(19) United States
(12) Patent Application Publication
(10) Pub. No.: US 2026/0245016 A1
(43) Pub. Date: Aug. 20, 2026

(54) DATA PROCESSING METHOD, APPARATUS AND DEVICE

(71) Applicant: Alipay (Hangzhou) Information Technology Co., Ltd., Hangzhou (CN)

(72) Inventors: Jiangbin ZHANG, Hangzhou (CN); Huijia ZHU, Hangzhou (CN); Zhiyuan ZHAO, Hangzhou (CN); Rui ZHANG, Hangzhou (CN)

(21) Appl. No.: 18/869,718

(22) PCT Filed: May 17, 2023
(86) PCT No.: PCT/CN2023/094852

§ 371 Date: Nov. 26, 2024

(30) Foreign Application Priority Data
May 31, 2022 (CN) 202210612033.6

(51) Int. Cl. G06Q 10/0635; G06F 16/334; G10L 15/02; G10L 15/06; G10L 15/08

(52) U.S. Cl. CPC G06Q 10/0635; G06F 16/3344; G10L 15/02; G10L 15/063; G10L 15/08

(57) ABSTRACT

Embodiments of this specification provide a data processing method, apparatus, and device. The method includes: obtaining a to-be-identified target feature vector, where the target feature vector is determined based on interaction content of a target user for a target service, and content restored based on the target feature vector is different from the interaction content; identifying the target feature vector based on a pre-trained risk speech identification model, to obtain an identification result for the target feature vector, where the risk speech identification model is trained based on a feature vector corresponding to a target risk speech; and determining, based on the identification result, whether a risk speech exists in the interaction content, to determine whether there is a risk in triggering execution of the target service.

### TECHNICAL FIELD

Embodiments of this specification relate to the field of data processing technologies, and in particular, to a data processing method, apparatus, and device.

### BACKGROUND

With rapid development of the Internet industry, network risks also increase accordingly. In a risk control scenario, whether a word matching a risk word in a pre-created prevention and control word table exists in interaction content between users can be detected based on the prevention and control word table, to determine whether the interaction content has a risk.

However, when a risk word data amount is relatively large and an updating speed is relatively fast, in the above-mentioned method, updating pressure of the prevention and control word table is relatively high, and there may be a case in which risk prevention and control cannot be performed because the prevention and control word table cannot be updated accurately in a timely manner. In view of this, a solution in which whether a risk speech exists in the interaction content can be determined accurately in a timely manner in the risk control scenario, to improve risk prevention and control efficiency and accuracy is needed.

### SUMMARY

Embodiments of this specification aim to provide a solution in which whether a risk speech exists in interaction content can be determined accurately in a timely manner in a risk control scenario, to improve risk prevention and control efficiency and accuracy.

To implement the above-mentioned technical solutions, the embodiments of this specification are implemented as follows: According to a first aspect, an embodiment of this specification provides a data processing method, including: obtaining a to-be-identified target feature vector, where the target feature vector is determined based on interaction content of a target user for a target service, and content restored based on the target feature vector is different from the interaction content; identifying the target feature vector based on a pre-trained risk speech identification model, to obtain an identification result for the target feature vector, where the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and determining, based on the identification result, whether a risk speech exists in the interaction content, to determine whether there is a risk in triggering execution of the target service.

According to a second aspect, an embodiment of this specification provides a data processing apparatus. The apparatus includes: a vector obtaining module, configured to obtain a to-be-identified target feature vector, where the target feature vector is determined based on interaction content of a target user for a target service, and content restored based on the target feature vector is different from the interaction content; a vector identification module, configured to identify the target feature vector based on a pre-trained risk speech identification model, to obtain an identification result for the target feature vector, where the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and a risk detection module, configured to determine, based on the identification result, whether a risk speech exists in the interaction content, to determine whether there is a risk in triggering execution of the target service.

According to a third aspect, an embodiment of this specification provides a data processing device. The data processing device includes: a processor; and a storage, configured to store computer-executable instructions. When the executable instructions are executed, the processor is enabled to perform the following operations: obtaining a to-be-identified target feature vector, where the target feature vector is determined based on interaction content of a target user for a target service, and content restored based on the target feature vector is different from the interaction content; identifying the target feature vector based on a pre-trained risk speech identification model, to obtain an identification result for the target feature vector, where the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and determining, based on the identification result, whether a risk speech exists in the interaction content, to determine whether there is a risk in triggering execution of the target service.

According to a fourth aspect, an embodiment of this specification provides a storage medium. The storage medium is configured to store computer-executable instructions, and when the executable instructions are executed, the following procedure is implemented: obtaining a to-be-identified target feature vector, where the target feature vector is determined based on interaction content of a target user for a target service, and content restored based on the target feature vector is different from the interaction content; identifying the target feature vector based on a pre-trained risk speech identification model, to obtain an identification result for the target feature vector, where the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and determining, based on the identification result, whether a risk speech exists in the interaction content, to determine whether there is a risk in triggering execution of the target service.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments recorded in this specification, and a person of ordinary skill in the art can still derive other drawings from these accompanying drawings without creative efforts.

FIG. 1A is a flowchart illustrating an embodiment of a data processing method, according to this specification;

FIG. 1B is a schematic diagram illustrating a processing process of an embodiment of a data processing method, according to this specification;

FIG. 2 is a schematic diagram illustrating a processing process of an embodiment of another data processing method, according to this specification;

FIG. 3 is a schematic diagram illustrating a risk speech filtering model, according to this specification;

FIG. 4 is a schematic diagram illustrating a risk speech filtering model, according to this specification;

FIG. 5A is a flowchart illustrating an embodiment of still another data processing method, according to this specification;

FIG. 5B is a schematic diagram illustrating a processing process of an embodiment of yet another data processing method, according to this specification;

FIG. 6 is a schematic structural diagram illustrating an embodiment of a data processing apparatus, according to this specification; and

FIG. 7 is a schematic structural diagram illustrating a data processing device, according to this specification.

### DESCRIPTION OF EMBODIMENTS

Embodiments of this specification provide a data processing method, apparatus, and device.

To make a person skilled in the art better understand the technical solutions in this specification, the following clearly and comprehensively describes the technical solutions in the embodiments of this specification with reference to the accompanying drawings in the embodiments of this specification. Clearly, the described embodiments are merely some but not all of the embodiments of this specification. All other embodiments obtained by a person of ordinary skill in the art based on the embodiment of this specification without creative efforts shall fall within the protection scope of this specification.

### Embodiment 1

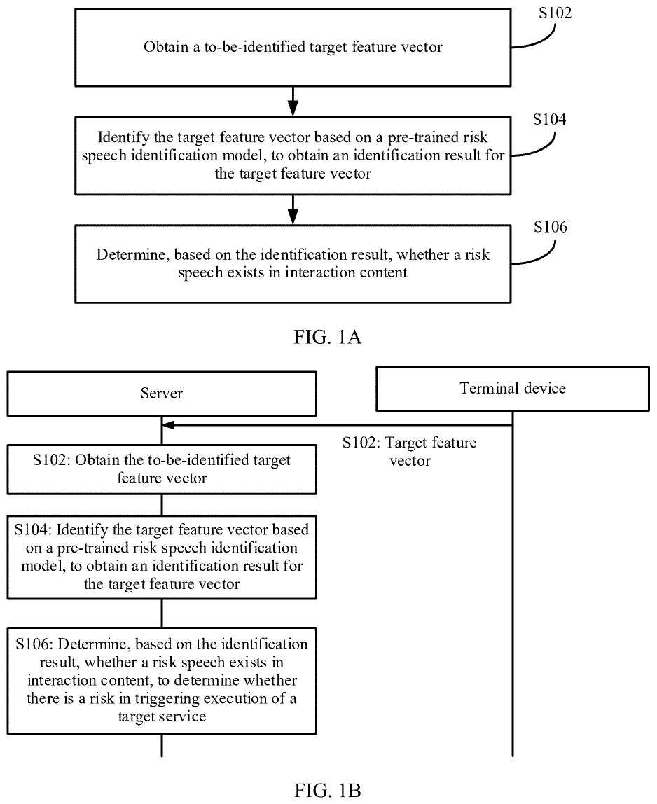

As shown in FIG. 1A and FIG. 1B, this embodiment of this specification provides a data processing method. The method can be performed by a server. The server can be an independent server, or can be a server cluster including a plurality of servers. The method can specifically include the following steps S102 to S106.

S102: Obtain a to-be-identified target feature vector.

The target feature vector can be determined based on interaction content of a target user for a target service. The target service can be any service related to user privacy, property security, etc. For example, the target service can be a resource transfer service or an instant messaging service. The interaction content of the target user for the target service can be interaction content between the target user and a resource receiving user for the resource transfer service, etc. The target feature vector can be a vector that corresponds to the interaction content and that is generated based on a preset vector generation model, and content restored based on the target feature vector is different from the interaction content. In other words, restoration processing is performed on the target feature vector, and the interaction content of the target user for the target service cannot be obtained.

During implementation, with rapid development of the Internet industry, network risks also increase accordingly. In a risk control scenario, whether a word matching a risk word in a pre-created prevention and control word table exists in interaction content between users can be detected based on the prevention and control word table, to determine whether the interaction content has a risk.

However, when a risk word data amount is relatively large and an updating speed is relatively fast, in the above-mentioned method, updating pressure of the prevention and control word table is relatively high, and there may be a case in which risk prevention and control cannot be performed because the prevention and control word table cannot be updated accurately in a timely manner. In view of this, a solution in which whether a risk speech exists in the interaction content can be determined accurately in a timely manner in the risk control scenario, to improve risk prevention and control efficiency and accuracy is needed. In view of this, this embodiment of this specification provides a technical solution that can resolve the above-mentioned problem. For details, references can be made to the following content.

For example, the target service is a resource transfer service in a resource management application installed in a terminal device (namely, the terminal device or a server). The target user can trigger a start of the resource management application, and trigger execution of the resource transfer service in the resource management application. The target user can interact with a user 1 for the resource transfer service. The terminal device can obtain interaction content between the target user and the user 1, and generate a target feature vector corresponding to the interaction content.

In addition, the terminal device can further send the generated target feature vector corresponding to the interaction content to the server. In other words, the server can obtain the target feature vector sent by the terminal device.

Because the content restored from the target feature vector is different from the interaction content, privacy preserving for the target user can be implemented.

In addition, after obtaining the interaction content of the target user for the target service, the terminal device can generate the target feature vector based on content in the interaction content other than content corresponding to the target user, to improve data processing efficiency. For example, that the target service is the resource transfer service.

When triggering execution of the resource transfer service, the target user can interact with the user 1. The interaction content obtained by the terminal device can be as follows: User 1: Please make a transfer before 12:00 today.
Target user: OK. How about 12:10?
User 1: OK.
Target user: OK. Is the transfer made to Account 1?
User 1: No. Please make the transfer to Account 2.

The terminal device can generate the target feature vector based on content corresponding to the user 1 in the interaction content, and send the target feature vector to the server for risk speech identification processing.

Alternatively, the terminal device can further perform matching processing on the interaction content of the target user for the target service based on a preset risk keyword, and when matching succeeds, generate the target feature vector based on interaction content that has an association relationship with content matching the risk keyword.

For example, if the risk keyword includes “transfer”, the terminal device can generate the target feature vector based on interaction content including “transfer” in the interaction content.

S104: Identify the target feature vector based on a pre-trained risk speech identification model, to obtain an identification result for the target feature vector.

The risk speech identification model can be trained based on a feature vector corresponding to a target risk speech, the feature vector corresponding to the target risk speech can be obtained by filtering a first feature vector corresponding to historical interaction content with a risk in the target service based on a pre-trained risk speech filtering model, and content restored based on the first feature vector is different from the interaction content.

During implementation, a prestored first feature vector that corresponds to the historical interaction content with a risk and that is determined when execution of the target service is triggered can be obtained based on a service identifier of the target service, the first feature vector is filtered based on the pre-trained risk speech filtering model, to obtain the feature vector corresponding to the target risk speech, and the risk speech identification model is trained based on the feature vector corresponding to the target risk speech, to obtain the trained risk speech identification model.

The target feature vector can be input into the pre-trained risk speech identification model, to obtain the identification result for the target feature vector. In this way, whether a risk speech exists in the interaction content of the target user for the target service can be identified based on the risk speech identification model, so that risk detection can be located at a speech level.

S106: Determine, based on the identification result, whether a risk speech exists in the interaction content, to determine whether there is a risk in triggering execution of the target service.

During implementation, when it is determined, based on the identification result, that a risk speech exists in the interaction content, preset prompt information can be sent to a target device used by the target user to trigger execution of the target service, to notify the target user that a risk speech exists in the interaction content.

In addition, because a risk speech updating speed is relatively fast, to improve model training accuracy, when it is determined, based on the identification result, that a risk speech exists in interaction content, the interaction content can be determined as historical interaction content. In other words, the target feature vector can be used as the first feature vector corresponding to the historical interaction content with a risk in the target service, and the risk speech filtering model is updated when a quantity of target feature vectors reaches a preset increment threshold.

If the target feature vector is a feature vector that is sent by the terminal device and that is generated based on the interaction content of the target user for the target service, the server can send the preset prompt information to the terminal device when determining, based on the identification result, that a risk speech exists in the interaction content, to remind the target user to avoid a security loss caused when the target user triggers execution of the target service.

This embodiment of this specification provides a data processing method. The to-be-identified target feature vector is obtained. The target feature vector can be determined based on the interaction content of the target user for the target service, and the content restored based on the target feature vector is different from the interaction content. The target feature vector is identified based on the pre-trained risk speech identification model, to obtain the identification result for the target feature vector. The risk speech identification model is trained based on the feature vector corresponding to the target risk speech, and the feature vector corresponding to the target risk speech is obtained by filtering the first feature vector corresponding to the historical interaction content with a risk in the target service based on the pre-trained risk speech filtering model. Whether a risk speech exists in the interaction content is determined based on the identification result, to determine whether there is a risk in triggering execution of the target service. In this way, because the content restored based on the target feature vector is different from the interaction content, security of privacy information of the target user can be ensured. In addition, the identification result for the target feature vector can be obtained based on the pre-trained risk speech identification model, to determine, based on the identification result, whether a risk speech exists in the interaction content, to improve risk speech determining efficiency and determining accuracy, that is, improve risk prevention and control efficiency and accuracy.

### Embodiment 2

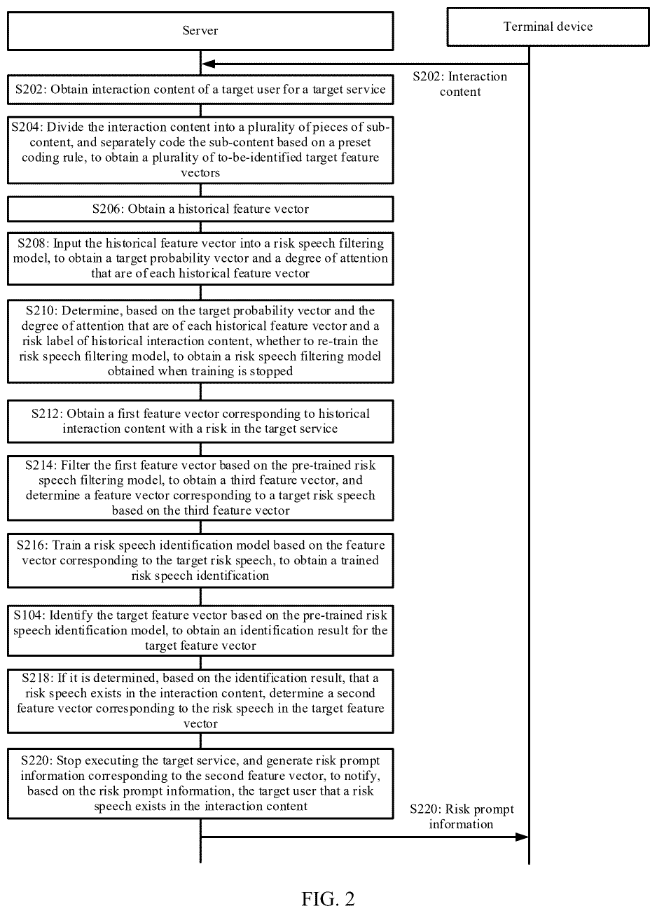

As shown in FIG. 2, this embodiment of this specification provides a data processing method. The method can be performed by a server. The server can be an independent server, or can be a server cluster including a plurality of servers. The method can specifically include the following steps S202 to S220.

S202: Obtain interaction content of a target user for a target service.

During implementation, a terminal device can mask the interaction content of the target user for the target service based on a preset masking algorithm, and send the masked interaction content to the server. That is, the interaction content received by the server does not include privacy data of the target user.

Alternatively, when receiving an authorization instruction of the target user (that is, the target user authorizes the server to process the interaction content), the terminal device can further send the interaction content of the target user for the target service to the server for processing.

S204: Divide the interaction content into a plurality of pieces of sub-content, and separately code the sub-content based on a preset coding rule, to obtain a plurality of to-be-identified target feature vectors.

Content restored based on the target feature vector is different from the interaction content.

During implementation, for example, content entered by the user each time in the interaction content can be used as one piece of sub-content. Specifically, it is assumed that the obtained interaction content is as follows: User 1: Please make a transfer before 12:00 today.
Target user: OK. How about 12:10?
User 1: OK.
Target user: OK. Is the transfer made to Account 1?
User 1: No. Please make the transfer to Account 2.

If the content entered by the user each time in the interaction content is used as one piece of sub-content, the interaction content can be divided into five pieces of sub-content. To be specific, sub-content obtained through division can include “Please make a transfer before 12:00 today”, “OK. How about 12:10?”, etc.

Alternatively, the interaction content can be divided into a plurality of pieces of sub-content based on a preset risk keyword (including a preset risk character type, for example, a value type or a time type). For example, if the risk keyword includes “account” and a time type, the interaction content can be divided into sub-content 1 corresponding to “account” and sub-content 2 corresponding to the time type. The sub-content 1 can be “OK. Is the transfer made to Account 1? No. Please make the transfer to Account 2”, and the sub-content 2 can be “Please make a transfer before 12:00 today. OK. How about 12:10?”

A division method for the sub-content is an optional and implementable division method. In an actual application scenario, there can be a plurality of different division methods. The division method can vary with the actual application scenario. This is not specifically limited in this embodiment of this specification.

After the sub-content is obtained, the sub-content can be separately coded based on the preset coding rule, to obtain a target feature vector corresponding to each piece of sub-content. The preset coding rule can be any irreversible coding rule. In other words, the content restored based on the target feature vector is different from the interaction content. In this way, privacy data of the target user is preserved.

S206: Obtain a historical feature vector.

The historical feature vector is determined based on first interaction content. Content restored based on the historical feature vector is different from the first interaction content, and the first interaction content can be interaction content with a risk.

During implementation, each piece of first interaction content can be divided into a plurality of pieces of first sub-content in the division method in S204, and each piece of first sub-content is coded based on the preset coding rule, to obtain a plurality of historical feature vectors.

S208: Input the historical feature vector into a risk speech filtering model, to obtain a target probability vector and a degree of attention that are of each historical feature vector.

The risk speech filtering model can be constructed based on a multiple instance learning algorithm (MIL). In this way, the risk speech filtering model constructed based on the MIL can be used to implement risk detection of the interaction content at a speech level.

During implementation, in actual applications, S208 can be processed in a plurality of manners. The following further provides an optional implementation. For details, references can be made to step 1 and step 2.

Step 1: Input the historical feature vector into a neural network layer of the risk speech filtering model, to obtain the target probability vector of each historical feature vector.

The neural network layer can be constructed based on an algorithm such as a convolutional neural network (CNN), a recurrent neural network (RNN), or a long short-term memory (LSTM), to determine a probability vector of a vector.

Step 2: Determine the degree of attention of each historical feature vector based on a preset attention mechanism and the target probability vector of each historical feature vector.

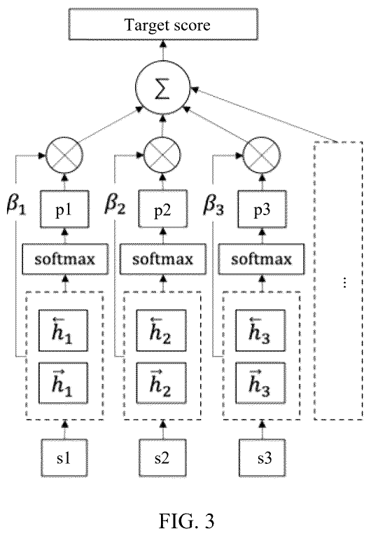

During implementation, as shown in FIG. 3, that the neural network layer is constructed based on a bidirectional LSTM is used as an example. After each historical feature vector (for example, a vector s1, a vector s2, or a vector s3) passes through the neural network layer, the target probability vector (for example, p1, p2, or p3) of each historical feature vector can be obtained after an activation function (for example, a softmax function) is performed. Based on the attention mechanism, degrees of attention (for example, β1, β2, and β3) between the historical feature vectors are obtained. Here, \vec{h₁}, \vec{h₂}, and \vec{h₃} are sequences that respectively correspond to the vector s1, the vector s2, and the vector s3 and that have the same direction, and [symbol] and [symbol] are sequences that are respectively opposite to the vector s1, the vector s2, and the vector s3 and that have the same direction. Here, \vec{h₁}, \vec{h₂}, and \vec{h₃} and [symbol] and [symbol] have different directions. A larger target probability vector indicates a higher risk that the first interaction content corresponding to the historical feature vector includes a risk speech.

S210: Determine, based on the target probability vector and the degree of attention that are of each historical feature vector and a risk label of historical interaction content, whether to re-train the risk speech filtering model, to obtain a risk speech filtering model obtained when training is stopped.

During implementation, in actual applications, S212 can be processed in a plurality of manners. The following further provides an optional implementation. For details, references can be made to step 1 and step 2.

Step 1: Determine a target score of each piece of first interaction content based on a target probability vector and a degree of attention that are of a historical feature vector corresponding to each piece of first interaction content.

During implementation, one or more historical feature vectors corresponding to each piece of first interaction content can be obtained, and the sum of products of target probability vectors and degrees of attention of the historical feature vectors corresponding to each piece of first interaction content is determined as the target score of each piece of first interaction content.

There can be a plurality of determining methods for the target score of each piece of first interaction content. Different determining methods can be selected based on different actual application scenarios. This is not specifically limited in this embodiment of this specification.

Step 2: Determine, based on a risk label and the target score of each piece of first interaction content, whether to re-train the risk speech filtering model.

During implementation, a prediction type (for example, a risk exists, a risk does not exist, or another case) of each piece of first interaction content can be determined based on the target score and a preset risk score threshold, and whether to re-train the risk speech filtering model is determined based on the prediction type and the risk label of each piece of first interaction content.

S212: Obtain a first feature vector corresponding to historical interaction content with a risk in the target service.

Content restored based on the first feature vector is different from the historical interaction content with a risk.

During implementation, each piece of historical interaction content can be divided into a plurality of pieces of historical sub-content in the division method in S204, and each piece of historical sub-content is coded based on the preset coding rule, to obtain a plurality of first feature vectors.

S214: Filter the first feature vector based on the pre-trained risk speech filtering model, to obtain a third feature vector, and determine a feature vector corresponding to a target risk speech based on the third feature vector.

During implementation, in actual applications, S214 can be processed in a plurality of manners. The following further provides an optional implementation. For details, references can be made to step 1 and step 2.

Step 1: Input the first feature vector into the pre-trained risk speech filtering model, to obtain a target probability vector and a degree of attention that are of each first feature vector. Step 2: Determine the third feature vector based on the target probability vector and the degree of attention that are of each first feature vector.

During implementation, a risk score of each first feature vector can be determined based on the target probability vector and the degree of attention that are of each first feature vector, and the third feature vector can be determined based on the risk score of each first feature vector.

For example, the product of the target probability vector and the degree of attention that are of each first feature vector can be determined as the risk score of each first feature vector, the first feature vector is sorted based on the risk score, and the third feature vector is determined based on the sorted first feature vector. For example, the first n first feature vectors with relatively large risk scores can be determined as third feature vectors.

There can be a plurality of determining methods for each third feature vector. Different determining methods can be selected based on different actual application scenarios. This is not specifically limited in this embodiment of this specification.

S216: Train a risk speech identification model based on the feature vector corresponding to the target risk speech, to obtain the trained risk speech identification model.

During implementation, in actual applications, S216 can be processed in a plurality of manners. The following provides an optional implementation. For details, references can be made to step A1 and step A2.

A1: Randomly select a predetermined quantity of third feature vectors from the historical feature vector.

During implementation, the third feature vector can be a feature vector without a risk label.

A2: Train the risk speech identification model in an unsupervised training manner based on the feature vector corresponding to the target risk speech and the third feature vector, to obtain the pre-trained risk speech identification model.

During implementation, because a risk speech updating speed is relatively fast, a data amount of samples with a risk label may be relatively small. Therefore, the risk speech identification model can be constructed based on a positive and unlabelled learning (PU learning) algorithm, and the risk speech identification model is trained in the unsupervised training manner.

In addition, the risk speech identification model can alternatively be a model constructed based on a preset classification algorithm, and the risk speech identification model is trained in a supervised training manner. The following further provides an optional implementation. For details, references can be made to step B1 and step B2.

B1: Randomly select a predetermined quantity of fifth feature vectors from a fourth feature vector in the historical feature vector.

First interaction content corresponding to the fourth feature vector can be interaction content without a risk.

B2: Train the risk speech identification model based on the feature vector corresponding to the target risk speech and the fifth feature vector, to obtain the pre-trained risk speech identification model.

During implementation, the fifth feature vector can be used as high-confidence white sample data, and the feature vector corresponding to the target risk speech can be used as black sample data. The risk speech identification model is trained, to obtain the pre-trained risk speech identification model, so that the trained risk speech identification model can hit interaction content between a malicious third party and a user without a risk as much as possible, and does not hit interaction content between users without a risk as much as possible.

S104: Identify the target feature vector based on the pre-trained risk speech identification model, to obtain an identification result for the target feature vector.

S218: If it is determined, based on the identification result, that a risk speech exists in the interaction content, determine a second feature vector corresponding to the risk speech in the target feature vector.

During implementation, it is assumed that the interaction content of the target user for the target service is as follows: User 1: Please make a transfer before 12:00 today.
Target user: OK. How about 12:10?
User 1: OK.
Target user: OK. Is the transfer made to Account 1?
User 1: No. Please make the transfer to Account 2.

The target feature vector includes a target feature vector 1 corresponding to the sub-content 1 and a target feature vector 2 corresponding to the sub-content 2. The sub-content 1 can be “OK. Is the transfer made to Account 1? No. Please make the transfer to Account 2”, and the sub-content 2 can be “Please make a transfer before 12:00 today. OK. How about 12:10?”

If it is determined, based on the identification result, that the target feature vector 1 is a feature vector corresponding to a risk speech, the target feature vector 1 can be determined as a second feature vector.

There can be a plurality of determining methods for the second feature vector. Different determining methods can be selected based on different actual application scenarios. This is not specifically limited in this embodiment of this specification.

S220: Stop executing the target service, and generate risk prompt information corresponding to the second feature vector, to notify, based on the risk prompt information, the target user that a risk speech exists in the interaction content.

During implementation, the server can generate the risk prompt information corresponding to the second feature vector. For example, the server can generate, based on location information of the second feature vector in interaction content corresponding to the target feature vector, risk prompt information carrying the location information. When the risk prompt information is sent to the terminal device, the terminal device determines, based on the location information in the risk prompt information, content with a risk speech in the interaction content, and combines the content and the risk prompt information, to output the content and the risk prompt information to the target user.

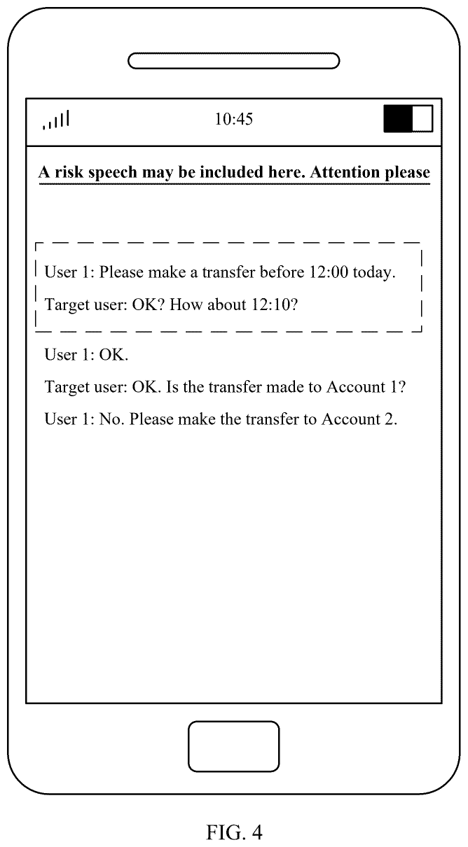

The interaction content in S218 is used as an example. If the target feature vector 2 corresponding to the sub-content 2 is a second feature vector, the risk prompt information generated by the server can be “A risk speech may be included here. Attention please”. The terminal device can output the risk prompt information shown in FIG. 4 based on location information of content corresponding to the target feature vector 2 in the interaction content.

This embodiment of this specification provides a data processing method. The to-be-identified target feature vector is obtained. The target feature vector can be determined based on the interaction content of the target user for the target service, and the content restored based on the target feature vector is different from the interaction content. The target feature vector is identified based on the pre-trained risk speech identification model, to obtain the identification result for the target feature vector. The risk speech identification model is trained based on the feature vector corresponding to the target risk speech, and the feature vector corresponding to the target risk speech is obtained by filtering the first feature vector corresponding to the historical interaction content with a risk in the target service based on the pre-trained risk speech filtering model. Whether a risk speech exists in the interaction content is determined based on the identification result, to determine whether there is a risk in triggering execution of the target service. In this way, because the content restored based on the target feature vector is different from the interaction content, security of privacy information of the target user can be ensured. In addition, the identification result for the target feature vector can be obtained based on the pre-trained risk speech identification model, to determine, based on the identification result, whether a risk speech exists in the interaction content, to improve risk speech determining efficiency and determining accuracy, that is, improve risk prevention and control efficiency and accuracy.

### Embodiment 3

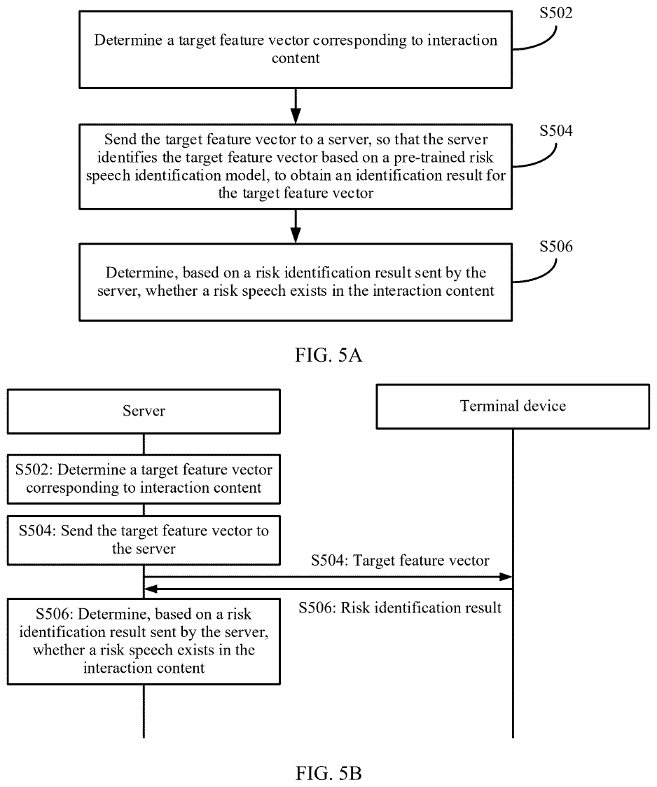

As shown in FIG. 5A and FIG. 5B, this embodiment of this specification provides a data processing method. The method can be performed by a terminal device. The terminal device can be a mobile terminal device such as a mobile phone or a tablet computer, or can be a terminal device such as a personal computer. The method can specifically include the following steps S502 to S506.

S502: Determine a target feature vector corresponding to interaction content.

Content restored based on the target feature vector is different from the interaction content.

During implementation, the terminal device divides the interaction content into a plurality of pieces of sub-content, and separately codes the sub-content based on a preset coding rule, to obtain a plurality of to-be-identified target feature vectors.

S504: Send the target feature vector to a server, so that the server identifies the target feature vector based on a pre-trained risk speech identification model, to obtain an identification result for the target feature vector.

The risk speech identification model can be trained based on a feature vector corresponding to a target risk speech, and the feature vector corresponding to the target risk speech is obtained by filtering a first feature vector corresponding to interaction content with a risk in a target service based on a pre-trained risk speech filtering model.

During implementation, the terminal device can send the target feature vector to a cloud server, so that the server identifies the target feature vector based on the pre-trained risk speech identification model, to obtain the identification result for the target feature vector.

S506: Determine, based on the risk identification result sent by the server, whether a risk speech exists in the interaction content.

During implementation, when the terminal device determines, based on the risk identification result sent by the server, whether a risk speech exists in the interaction content, preset prompt information can be output, to notify the target user that there is a risk in executing the target service; or the terminal device can output corresponding prompt information for content corresponding to the risk speech in the interaction content based on the risk identification result, to output the prompt information to the target user in a targeted manner.

This embodiment of this specification provides the data processing method. In this way, because the content restored based on the target feature vector is different from the interaction content, security of privacy information of the target user can be ensured. In addition, the identification result for the target feature vector can be obtained based on the pre-trained risk speech identification model, to determine, based on the identification result, whether a risk speech exists in the interaction content, to improve risk speech determining efficiency and determining accuracy, that is, improve risk prevention and control efficiency and accuracy.

### Embodiment 4

The data processing methods provided in the embodiments of this specification are described above. Based on the same idea, this embodiment of this specification further provides a data processing apparatus, as shown in FIG. 6.

The data processing apparatus includes a vector obtaining module 601, a vector identification module 602, and a risk detection module 603. The vector obtaining module 601 is configured to obtain a to-be-identified target feature vector. The target feature vector is determined based on interaction content of a target user for a target service, and content restored based on the target feature vector is different from the interaction content. The vector identification module 602 is configured to identify the target feature vector based on a pre-trained risk speech identification model, to obtain an identification result for the target feature vector. The risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model. The risk detection module 603 is configured to determine, based on the identification result, whether a risk speech exists in the interaction content, to determine whether there is a risk in triggering execution of the target service.

In this embodiment of this specification, the risk detection module 603 is configured to: if it is determined, based on the identification result, that a risk speech exists in the interaction content, determine a second feature vector corresponding to the risk speech in the target feature vector; and stop executing the target service, and generate risk prompt information corresponding to the second feature vector, to notify, based on the risk prompt information, the target user that a risk speech exists in the interaction content.

In this embodiment of this specification, the apparatus further includes: a vector extraction module, configured to obtain the first feature vector corresponding to the historical interaction content with a risk in the target service, where content restored based on the first feature vector is different from the historical interaction content with a risk; a vector filtering module, configured to: filter the first feature vector based on the pre-trained risk speech filtering model, to obtain a third feature vector, and determine the feature vector corresponding to the target risk speech based on the third feature vector; and a model training module, configured to train a risk speech identification model based on the feature vector corresponding to the target risk speech, to obtain the trained risk speech identification model.

In this embodiment of this specification, the risk speech filtering model is constructed based on a multiple instance learning algorithm, and the apparatus further includes: a first obtaining module, configured to obtain a historical feature vector, where the historical feature vector is determined by first interaction content, and content restored based on the historical feature vector is different from the first interaction content; a data obtaining module, configured to input the historical feature vector into the risk speech filtering model, to obtain a target probability vector and a degree of attention that are of each historical feature vector; and a model obtaining module, configured to determine, based on the target probability vector and the degree of attention that are of each historical feature vector and a risk label of the historical interaction content, whether to re-train the risk speech filtering model, to obtain a risk speech filtering model obtained when training is stopped.

In this embodiment of this specification, the data obtaining module is configured to: input the historical feature vector into a neural network layer of the risk speech filtering model, to obtain the target probability vector of each historical feature vector; and
determine the degree of attention of each historical feature vector based on a preset attention mechanism and the target probability vector of each historical feature vector.

In this embodiment of this specification, the model obtaining module is configured to: determine a target score of each piece of first interaction content based on a target probability vector and a degree of attention that are of a historical feature vector corresponding to each piece of first interaction content; and determine, based on a risk label and the target score of each piece of first interaction content, whether to re-train the risk speech filtering model.

In this embodiment of this specification, the vector filtering module is configured to input the first feature vector into the pre-trained risk speech filtering model, to obtain a target probability vector and a degree of attention that are of each first feature vector; and
determine the third feature vector based on the target probability vector and the degree of attention that are of each first feature vector.

In this embodiment of this specification, the risk detection module 603 is configured to: determine a risk score of each first feature vector based on the target probability vector and the degree of attention that are of each first feature vector, and determine the third feature vector based on the risk score of each first feature vector.

In this embodiment of this specification, the model training module is configured to: randomly select a predetermined quantity of third feature vectors from the historical feature vector; and train the risk speech identification model in an unsupervised training manner based on the feature vector corresponding to the target risk speech and the third feature vector, to obtain the pre-trained risk speech identification model.

In this embodiment of this specification, the model training module is configured to: randomly select a predetermined quantity of fifth feature vectors from a fourth feature vector in the historical feature vector, where first interaction content corresponding to the fourth feature vector is interaction content without a risk; and train the risk speech identification model based on the feature vector corresponding to the target risk speech and the fifth feature vector, to obtain the pre-trained risk speech identification model.

In this embodiment of this specification, the vector obtaining module 601 is configured to: obtain the interaction content of the target user for the target service; and divide the interaction content into a plurality of pieces of sub-content, and separately code the sub-content based on a preset coding rule, to obtain a plurality of to-be-identified target feature vectors.

This embodiment of this specification provides the data processing apparatus. The to-be-identified target feature vector is obtained. The target feature vector can be determined based on the interaction content of the target user for the target service, and the content restored based on the target feature vector is different from the interaction content. The target feature vector is identified based on the pre-trained risk speech identification model, to obtain the identification result for the target feature vector. The risk speech identification model is trained based on the feature vector corresponding to the target risk speech, and the feature vector corresponding to the target risk speech is obtained by filtering the first feature vector corresponding to the historical interaction content with a risk in the target service based on the pre-trained risk speech filtering model. Whether a risk speech exists in the interaction content is determined based on the identification result, to determine whether there is a risk in triggering execution of the target service. In this way, because the content restored based on the target feature vector is different from the interaction content, security of privacy information of the target user can be ensured. In addition, the identification result for the target feature vector can be obtained based on the pre-trained risk speech identification model, to determine, based on the identification result, whether a risk speech exists in the interaction content, to improve risk speech determining efficiency and determining accuracy, that is, improve risk prevention and control efficiency and accuracy.

### Embodiment 5

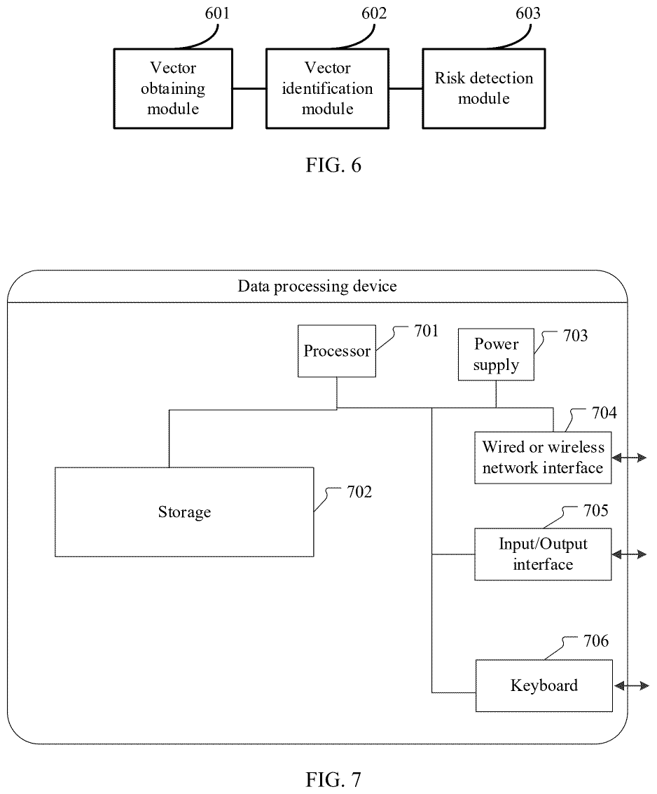

Based on the same idea, an embodiment of this specification further provides a data processing device, as shown in FIG. 7.

The data processing device can vary greatly based on configuration or performance, and can include one or more processors 701 and a storage 702. The storage 702 can store one or more applications or data. The storage 702 can be a transitory storage or persistent storage. The application stored in the storage 702 can include one or more modules (not shown in the figure), and each module can include a series of computer-executable instructions in the data processing device. Still further, the processor 701 can be configured to communicate with the storage 702, to execute a series of computer-executable instructions in the storage 702 on the data processing device. The data processing device can further include one or more power supplies 703, one or more wired or wireless network interfaces 704, one or more input/output interfaces 705, and one or more keyboards 706.

Specifically, in this embodiment, the data processing device includes a storage and one or more programs. The one or more programs are stored in the storage. The one or more programs can include one or more modules. Each module can include a series of computer-executable instructions in the data processing device. One or more processors are configured to execute the one or more programs, including performing the following computer-executable instructions: obtaining a to-be-identified target feature vector, where the target feature vector is determined based on interaction content of a target user for a target service, and content restored based on the target feature vector is different from the interaction content; identifying the target feature vector based on a pre-trained risk speech identification model, to obtain an identification result for the target feature vector, where the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and determining, based on the identification result, whether a risk speech exists in the interaction content, to determine whether there is a risk in triggering execution of the target service.

Optionally, the determining, based on the identification result, whether a risk speech exists in the interaction content, to determine whether there is a risk in triggering execution of the target service includes: if it is determined, based on the identification result, that a risk speech exists in the interaction content, determining a second feature vector corresponding to the risk speech in the target feature vector; and stopping executing the target service, and generating risk prompt information corresponding to the second feature vector, to notify, based on the risk prompt information, the target user that a risk speech exists in the interaction content.

Optionally, before the identifying the target feature vector based on a pre-trained risk speech identification model, to obtain an identification result for the target feature vector, the following operations are further included: obtaining the first feature vector corresponding to the historical interaction content with a risk in the target service, where content restored based on the first feature vector is different from the historical interaction content with a risk; filtering the first feature vector based on the pre-trained risk speech filtering model, to obtain a third feature vector, and determining the feature vector corresponding to the target risk speech based on the third feature vector; and training a risk speech identification model based on the feature vector corresponding to the target risk speech, to obtain the trained risk speech identification model.

Optionally, the risk speech filtering model is constructed based on a multiple instance learning algorithm, and before the filtering the first feature vector based on the pre-trained risk speech filtering model, to obtain a third feature vector, the following operations are further included:
obtaining a historical feature vector, where the historical feature vector is determined based on first interaction content, and content restored based on the historical feature vector is different from the first interaction content; inputting the historical feature vector into the risk speech filtering model, to obtain a target probability vector and a degree of attention that are of each historical feature vector; and determining, based on the target probability vector and the degree of attention that are of each historical feature vector and a risk label of the historical interaction content, whether to re-train the risk speech filtering model, to obtain a risk speech filtering model obtained when training is stopped.

Optionally, the inputting the historical feature vector into the risk speech filtering model, to obtain a target probability vector and a degree of attention that are of each historical feature vector includes: inputting the historical feature vector into a neural network layer of the risk speech filtering model, to obtain the target probability vector of each historical feature vector; and determining the degree of attention of each historical feature vector based on a preset attention mechanism and the target probability vector of each historical feature vector.

Optionally, the determining, based on the target probability vector and the degree of attention that are of each historical feature vector and a risk label of the historical interaction content, whether to re-train the risk speech filtering model includes:
determining a target score of each piece of first interaction content based on a target probability vector and a degree of attention that are of a historical feature vector corresponding to each piece of first interaction content; and determining, based on a risk label and the target score of each piece of first interaction content, whether to re-train the risk speech filtering model.

Optionally, the filtering the first feature vector based on the pre-trained risk speech filtering model, to obtain a third feature vector includes: inputting the first feature vector into the pre-trained risk speech filtering model, to obtain a target probability vector and a degree of attention that are of each first feature vector; and determining the third feature vector based on the target probability vector and the degree of attention that are of each first feature vector.

Optionally, the determining the third feature vector based on the target probability vector and the degree of attention that are of each first feature vector includes: determining a risk score of each first feature vector based on the target probability vector and the degree of attention that are of each first feature vector, and determining the third feature vector based on the risk score of each first feature vector.

Optionally, the training a risk speech identification model based on the feature vector corresponding to the target risk speech, to obtain the pre-trained risk speech identification model includes: randomly selecting a predetermined quantity of third feature vectors from the historical feature vector; and training the risk speech identification model in an unsupervised training manner based on the feature vector corresponding to the target risk speech and the third feature vector, to obtain the pre-trained risk speech identification model.

Optionally, the training a risk speech identification model based on the feature vector corresponding to the target risk speech, to obtain the pre-trained risk speech identification model includes: randomly selecting a predetermined quantity of fifth feature vectors from a fourth feature vector in the historical feature vector, where first interaction content corresponding to the fourth feature vector is interaction content without a risk; and training the risk speech identification model based on the feature vector corresponding to the target risk speech and the fifth feature vector, to obtain the pre-trained risk speech identification model.

Optionally, the obtaining a to-be-identified target feature vector includes: obtaining the interaction content of the target user for the target service; and dividing the interaction content into a plurality of pieces of sub-content, and separately coding the sub-content based on a preset coding rule, to obtain a plurality of to-be-identified target feature vectors.

This embodiment of this specification provides the data processing device. The to-be-identified target feature vector is obtained. The target feature vector can be determined based on the interaction content of the target user for the target service, and the content restored based on the target feature vector is different from the interaction content. The target feature vector is identified based on the pre-trained risk speech identification model, to obtain the identification result for the target feature vector. The risk speech identification model is trained based on the feature vector corresponding to the target risk speech, and the feature vector corresponding to the target risk speech is obtained by filtering the first feature vector corresponding to the historical interaction content with a risk in the target service based on the pre-trained risk speech filtering model. Whether a risk speech exists in the interaction content is determined based on the identification result, to determine whether there is a risk in triggering execution of the target service. In this way, because the content restored based on the target feature vector is different from the interaction content, security of privacy information of the target user can be ensured. In addition, the identification result for the target feature vector can be obtained based on the pre-trained risk speech identification model, to determine, based on the identification result, whether a risk speech exists in the interaction content, to improve risk speech determining efficiency and determining accuracy, that is, improve risk prevention and control efficiency and accuracy.

### Embodiment 6

This embodiment of this specification further provides a computer-readable storage medium. A computer program is stored in the computer-readable storage medium. When the computer program is executed by a processor, each process of the embodiment of the data processing method is implemented, and the same technical effect can be achieved. To avoid repetition, details are omitted here for simplicity. The computer-readable storage medium is, for example, a read-only memory (ROM), a random access memory (RAM), a magnetic disk, or an optical disc.

This specification embodiment provides the computer-readable storage medium. The to-be-identified target feature vector is obtained. The target feature vector can be determined based on the interaction content of the target user for the target service, and the content restored based on the target feature vector is different from the interaction content. The target feature vector is identified based on the pre-trained risk speech identification model, to obtain the identification result for the target feature vector. The risk speech identification model is trained based on the feature vector corresponding to the target risk speech, and the feature vector corresponding to the target risk speech is obtained by filtering the first feature vector corresponding to the historical interaction content with a risk in the target service based on the pre-trained risk speech filtering model. Whether a risk speech exists in the interaction content is determined based on the identification result, to determine whether there is a risk in triggering execution of the target service. In this way, because the content restored based on the target feature vector is different from the interaction content, security of privacy information of the target user can be ensured. In addition, the identification result for the target feature vector can be obtained based on the pre-trained risk speech identification model, to determine, based on the identification result, whether a risk speech exists in the interaction content, to improve risk speech determining efficiency and determining accuracy, that is, improve risk prevention and control efficiency and accuracy.

Some specific embodiments of this specification are described above. Other embodiments fall within the scope of the appended claims. In some cases, actions or steps described in the claims can be performed in a sequence different from that in the embodiments and desired results can still be achieved. In addition, the process depicted in the accompanying drawings does not necessarily need a particular sequence to achieve the desired results. In some implementations, multi-tasking and parallel processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a user through device programming. The designer independently performs programming to “integrate” a digital system to a PLD without requesting a chip manufacturer to design and manufacture an application-specific integrated circuit chip. In addition, at present, instead of manually manufacturing an integrated circuit chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. It should also be clear to a person skilled in the art that a hardware circuit for implementing a logical method procedure can be easily obtained by performing slight logic programming on the method procedure by using the above-mentioned several hardware description languages and programming the method procedure into an integrated circuit.

A controller can be implemented by using any appropriate method. For example, the controller can be a microprocessor or a processor, or a computer readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. A storage controller can also be implemented as a part of the control logic of the storage. A person skilled in the art also knows that in addition to implementing the controller by using only the computer-readable program code, logic programming can be performed on method steps to enable the controller to implement the same function in a form of a logic gate, a switch, an application specific integrated circuit, a programmable logic controller, or an embedded microcontroller. Therefore, the controller can be considered as a hardware component, and an apparatus configured to implement various functions in the controller can also be considered as a structure in the hardware component. Alternatively, an apparatus configured to implement various functions can even be considered as both a software module implementing the method and a structure in the hardware component.

The systems, apparatuses, modules, or units described in the above-mentioned embodiments can be specifically implemented by a computer chip or an entity, or can be implemented by a product having a certain function. A typical implementation device is a computer. Specifically, the computer can be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of one or more embodiments of this specification, the functions of each unit can be implemented in one or more pieces of software and/or hardware.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The embodiments of this specification are described with reference to the flowcharts and/or block diagrams of the method, the device (system), and the computer program product according to the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

Alternatively, these computer program instructions can be stored in a computer-readable storage that can instruct a computer or another programmable data processing device to work in a specific manner, so the instructions stored in the computer-readable storage generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPU), an input/output interface, a network interface, and a memory.

The memory may include a non-persistent memory, a random access memory (RAM), a nonvolatile memory, and/or another form in a computer-readable medium, for example, a read-only memory (ROM) or a flash memory (flash RAM). The memory is an example of the computer-readable medium.

The computer-readable medium includes persistent, non-persistent, movable, and unmovable media that can store information by using any method or technology. Information can be a computer-readable instruction, a data structure, a program module, or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information accessible by a computing device. Based on the definition in this specification, the computer-readable medium does not include transitory media such as a modulated data signal and carrier.

It is worthwhile to further note that the terms “include”, “comprise”, or any other variant thereof are intended to cover a non-exclusive inclusion, so that a process, a method, a product, or a device that includes a list of elements not only includes those elements but also includes other elements which are not expressly listed, or further includes elements inherent to such process, method, product, or device. Without more constraints, an element preceded by “includes a . . . ” does not preclude the existence of additional identical elements in the process, method, product, or device that includes the element.

A person skilled in the art should understand that the embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage, a CD-ROM, an optical storage, etc.) that include computer-usable program code.

The one or more embodiments of this specification can be described in the general context of computer-executable instructions, for example, a program module. Usually, the program module includes a routine, a program, an object, a component, a data structure, etc. for executing a specific task or implementing a specific abstract data type. Alternatively, the one or more embodiments of this specification can be practiced in distributed computing environments. In the distributed computing environments, tasks are executed by remote processing devices connected by using a communication network. In the distributed computing environments, the program module can be located in a local and remote computer storage medium including a storage device.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments.

The above-mentioned descriptions are merely some embodiments of this specification and are not intended to limit this specification. A person skilled in the art can make various changes and variations to this specification. Any modification, equivalent replacement, or improvement made without departing from the spirit and principle of this specification shall fall within the scope of the claims in this specification.

1. A data processing method, comprising:
obtaining a to-be-identified target feature vector, wherein the target feature vector is determined based on interaction content of a target user for a target service, and content restored based on the target feature vector is different from the interaction content;
identifying the target feature vector based on a pre-trained risk speech identification model, to obtain an identification result for the target feature vector, wherein the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and
determining, based on the identification result, whether a risk speech exists in the interaction content, to determine whether there is a risk in triggering execution of the target service.

2. The method according to claim 1, wherein the determining, based on the identification result, whether a risk speech exists in the interaction content, to determine whether there is a risk in triggering execution of the target service comprises:
upon determining, based on the identification result, that a risk speech exists in the interaction content, determining a second feature vector corresponding to the risk speech in the target feature vector; and
stopping executing the target service, and generating risk prompt information corresponding to the second feature vector, to notify, based on the risk prompt information, the target user that a risk speech exists in the interaction content.

3. The method according to claim 2, wherein before the identifying the target feature vector based on a pre-trained risk speech identification model, to obtain an identification result for the target feature vector, the method further comprises:
obtaining the first feature vector corresponding to the historical interaction content with a risk in the target service, wherein content restored based on the first feature vector is different from the historical interaction content with a risk;
filtering the first feature vector based on the pre-trained risk speech filtering model, to obtain a third feature vector, and determining the feature vector corresponding to the target risk speech based on the third feature vector; and
training a risk speech identification model based on the feature vector corresponding to the target risk speech, to obtain the trained risk speech identification model.

4. The method according to claim 3, wherein the risk speech filtering model is constructed based on a multiple instance learning algorithm, and before the filtering the first feature vector based on the pre-trained risk speech filtering model, to obtain a third feature vector, the method further comprises:
obtaining a historical feature vector, wherein the historical feature vector is determined based on first interaction content, and content restored based on the historical feature vector is different from the first interaction content;
inputting the historical feature vector into the risk speech filtering model, to obtain a target probability vector and a degree of attention that are of each historical feature vector; and
determining, based on the target probability vector and the degree of attention that are of each historical feature vector and a risk label of the historical interaction content, whether to re-train the risk speech filtering model, to obtain a risk speech filtering model obtained when training is stopped.

5. The method according to claim 4, wherein the inputting the historical feature vector into the risk speech filtering model, to obtain a target probability vector and a degree of attention that are of each historical feature vector comprises:
inputting the historical feature vector into a neural network layer of the risk speech filtering model, to obtain the target probability vector of each historical feature vector; and
determining the degree of attention of each historical feature vector based on a preset attention mechanism and the target probability vector of each historical feature vector.

6. The method according to claim 5, wherein the determining, based on the target probability vector and the degree of attention that are of each historical feature vector and a risk label of the historical interaction content, whether to re-train the risk speech filtering model comprises:
determining a target score of each piece of first interaction content based on a target probability vector and a degree of attention that are of a historical feature vector corresponding to each piece of first interaction content; and
determining, based on a risk label and the target score of each piece of first interaction content, whether to re-train the risk speech filtering model.

7. The method according to claim 6, wherein the filtering the first feature vector based on the pre-trained risk speech filtering model, to obtain a third feature vector comprises:
inputting the first feature vector into the pre-trained risk speech filtering model, to obtain a target probability vector and a degree of attention that are of each first feature vector; and
determining the third feature vector based on the target probability vector and the degree of attention that are of each first feature vector.

8. The method according to claim 7, wherein the determining the third feature vector based on the target probability vector and the degree of attention that are of each first feature vector comprises:
determining a risk score of each first feature vector based on the target probability vector and the degree of attention that are of each first feature vector, and determining the third feature vector based on the risk score of each first feature vector.

9. The method according to claim 8, wherein the training a risk speech identification model based on the feature vector corresponding to the target risk speech, to obtain the pre-trained risk speech identification model comprises:
randomly selecting a predetermined quantity of third feature vectors from the historical feature vector; and
training the risk speech identification model in an unsupervised training manner based on the feature vector corresponding to the target risk speech and the third feature vector, to obtain the pre-trained risk speech identification model.

10. The method according to claim 8, wherein the training a risk speech identification model based on the feature vector corresponding to the target risk speech, to obtain the pre-trained risk speech identification model comprises:
randomly selecting a predetermined quantity of fifth feature vectors from a fourth feature vector in the historical feature vector, wherein first interaction content corresponding to the fourth feature vector is interaction content without a risk; and
training the risk speech identification model based on the feature vector corresponding to the target risk speech and the fifth feature vector, to obtain the pre-trained risk speech identification model.

11. The method according to claim 1, wherein the obtaining a to-be-identified target feature vector comprises:
obtaining the interaction content of the target user for the target service; and
dividing the interaction content into a plurality of pieces of sub-content, and separately coding the sub-content based on a preset coding rule, to obtain a plurality of the to-be-identified target feature vector.

12. (canceled)

13. A computing device, wherein the device comprises:
a processor; and
a storage, configured to store computer-executable instructions, wherein when the executable instructions are executed, the processor is enabled to perform a data processing method, the method comprising:
obtaining a to-be-identified target feature vector, wherein the target feature vector is determined based on interaction content of a target user for a target service, and content restored based on the target feature vector is different from the interaction content;
identifying the target feature vector based on a pre-trained risk speech identification model, to obtain an identification result for the target feature vector, wherein the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and
determining, based on the identification result, whether a risk speech exists in the interaction content, to determine whether there is a risk in triggering execution of the target service.

14. A non-transitory computer-readable storage medium, wherein the computer-readable storage medium is configured to store computer-executable instructions, and when the executable instructions are executed by a processor, the processor is caused to implement a data processing method, the method comprising:
obtaining a to-be-identified target feature vector, wherein the target feature vector is determined based on interaction content of a target user for a target service, and content restored based on the target feature vector is different from the interaction content;
identifying the target feature vector based on a pre-trained risk speech identification model, to obtain an identification result for the target feature vector, wherein the risk speech identification model is trained based on a feature vector corresponding to a target risk speech, and the feature vector corresponding to the target risk speech is obtained by filtering a first feature vector corresponding to historical interaction content with a risk in the target service based on a pre-trained risk speech filtering model; and
determining, based on the identification result, whether a risk speech exists in the interaction content, to determine whether there is a risk in triggering execution of the target service.

15. The computing device according to claim 13, wherein the determining, based on the identification result, whether a risk speech exists in the interaction content, to determine whether there is a risk in triggering execution of the target service comprises:
upon determining, based on the identification result, that a risk speech exists in the interaction content, determining a second feature vector corresponding to the risk speech in the target feature vector; and
stopping executing the target service, and generating risk prompt information corresponding to the second feature vector, to notify, based on the risk prompt information, the target user that a risk speech exists in the interaction content.

16. The computing device according to claim 15, wherein before the identifying the target feature vector based on a pre-trained risk speech identification model, to obtain an identification result for the target feature vector, the computing device is further caused to:
obtain the first feature vector corresponding to the historical interaction content with a risk in the target service, wherein content restored based on the first feature vector is different from the historical interaction content with a risk;
filter the first feature vector based on the pre-trained risk speech filtering model, to obtain a third feature vector, and determining the feature vector corresponding to the target risk speech based on the third feature vector; and
train a risk speech identification model based on the feature vector corresponding to the target risk speech, to obtain the trained risk speech identification model.

17. The computing device according to claim 16, wherein the risk speech filtering model is constructed based on a multiple instance learning algorithm, and before the filtering the first feature vector based on the pre-trained risk speech filtering model, to obtain a third feature vector, the computing device is further caused to:
obtain a historical feature vector, wherein the historical feature vector is determined based on first interaction content, and content restored based on the historical feature vector is different from the first interaction content;
input the historical feature vector into the risk speech filtering model, to obtain a target probability vector and a degree of attention that are of each historical feature vector; and
determine, based on the target probability vector and the degree of attention that are of each historical feature vector and a risk label of the historical interaction content, whether to re-train the risk speech filtering model, to obtain a risk speech filtering model obtained when training is stopped.

18. The computing device according to claim 17, wherein the inputting the historical feature vector into the risk speech filtering model, to obtain a target probability vector and a degree of attention that are of each historical feature vector comprises:
inputting the historical feature vector into a neural network layer of the risk speech filtering model, to obtain the target probability vector of each historical feature vector; and
determining the degree of attention of each historical feature vector based on a preset attention mechanism and the target probability vector of each historical feature vector.

19. The computing device according to claim 20, wherein the determining, based on the target probability vector and the degree of attention that are of each historical feature vector and a risk label of the historical interaction content, whether to re-train the risk speech filtering model comprises:
determining a target score of each piece of first interaction content based on a target probability vector and a degree of attention that are of a historical feature vector corresponding to each piece of first interaction content; and
determining, based on a risk label and the target score of each piece of first interaction content, whether to re-train the risk speech filtering model

20. The computing device according to claim 19, wherein the filtering the first feature vector based on the pre-trained risk speech filtering model, to obtain a third feature vector comprises:
inputting the first feature vector into the pre-trained risk speech filtering model, to obtain a target probability vector and a degree of attention that are of each first feature vector; and
determining the third feature vector based on the target probability vector and the degree of attention that are of each first feature vector.

21. The computing device according to claim 20, wherein the determining the third feature vector based on the target probability vector and the degree of attention that are of each first feature vector comprises:
determining a risk score of each first feature vector based on the target probability vector and the degree of attention that are of each first feature vector, and determining the third feature vector based on the risk score of each first feature vector.
